(19) United States
(12) Patent Application Publication
(10) Pub. No.: US 2013/0247038 A1
(43) Pub. Date: Sep. 19, 2013

(54) DEVICE-INTEGRATION METHOD, TERMINAL-APPARATUS, AND DISTRIBUTED MULTI-TERMINAL-APPARATUS SYSTEM

(71) Applicant: SONY CORPORATION, Tokyo (JP)

(72) Inventors: Yu LUO, Pudong New Area Shanghai (CN); Ting WANG, Pudong New Area Shanghai (CN)

(73) Assignee: Sony Corporation, Tokyo (JP)

(21) Appl. No.: 13/799,427

(22) Filed: Mar. 13, 2013

(30) Foreign Application Priority Data
Mar. 14, 2012 (CN) 201210067455.6

(51) Int. Cl. G06F 9/455

(52) U.S. Cl. CPC G06F 9/45533
USPC 718/1

(57) ABSTRACT

A device-integration method, a terminal-apparatus and a distributed multi-terminal-apparatus system. The device-integration method is applied in a terminal-apparatus on which there runs a virtual-machine-hypervisor, and the method includes: the virtual-machine-hypervisor scanning a bus configuration storage unit of the terminal-apparatus, to acquire local-device-information on each of the local devices that the terminal-apparatus has; the virtual-machine-hypervisor sending the acquired local-device-information to an adjacent terminal-apparatus, and receiving, from the adjacent terminal-apparatus, remote-device-information on each of the remote devices that the adjacent terminal has; the virtual-machine-hypervisor organizing the local devices and the remote devices on a virtual bus of the terminal-apparatus.

### FIELD OF THE INVENTION

The present invention relates to the virtualization technology, and particularly relates to a device-integration method based on the virtualization technology, a terminal-apparatus using the device-integration method, and a distributed multi-terminal-apparatus system.

### BACKGROUND OF THE INVENTION

Virtualization is a broad term which usually refers to computing elements running on a virtual basis, rather than on the basis of a real environment. Virtualization technology can expand capacity of hardware, and simplify re-configuration processes of software. Virtualization technology of CPU may be a single-CPU simulating multi-CPUs which operates concurrently, allowing a platform to run multiple operating systems at the same time, and applications all being able to run in mutually independent spaces, thus the efficiency of a computer is significantly improved. Virtualization technology, through abstraction of resources, by separating physical hardware devices from operating systems, provides a higher utilization and flexibility of resources.

In recent years, with the emergence of cluster computing as well as the needs for high-performance computing, some special applications require more powerful physical resources that a single terminal-apparatus can not meet such application requirements; therefore, it has become an inevitable trend to effectively integrate physical device-resources of terminal-apparatuses and supply them to upper applications. Distributed virtual machines use distributed virtual-machine-hypervisors to manage hardware resources, and through collaboration, provide unified physical resources to guest operating systems running on an upper level, so that they met the requirements of high-level services. A bus is a set of public communication trunk-lines for transferring information among various functional components of terminal-apparatuses, and generally, it is a transmission harness composed of physical wires; in conventional computer architecture, all devices are connected through a variety of buses, especially system buses, such as ISA, AGP, PCI/PCIE etc., which are all physically existing buses. An operating system scans these buses to obtain information on individual devices connected to the buses.

In virtualization technology, a virtual-machine-hypervisor, based on mapping local buses, can provide a virtualized bus and device collections for a guest operating system. Such a virtualized bus is referred to as virtual bus. Therefore, it is desirable to provide a device-integration method based on virtualization technology, a terminal-apparatus using the device-integration method, and a distributed multi-terminal-apparatus system comprising a plurality of terminal-apparatuses, in which, by utilizing a virtual bus, it achieves an effective integration of both device-resources of local terminal-apparatuses and device-resources of remote terminal-apparatuses, as well as a real-time update of the device-information.

### SUMMARY OF THE INVENTION

According to an embodiment of the present invention, there is provided a device-integration method, the method is applied in a terminal-apparatus on which there runs a virtual-machine-hypervisor, and the method comprises: the virtual-machine-hypervisor scans a bus configuration storage-unit of the terminal-apparatus, to acquire local-device-information on each of the local devices that the terminal-apparatus has; the virtual-machine-hypervisor sends the acquired local-device-information to an adjacent terminal-apparatus, and receives, from the adjacent terminal-apparatus, remote-device-information on each of the remote devices that the adjacent terminal has; the virtual-machine-hypervisor organizes the local devices and the remote devices on a virtual bus of the terminal-apparatus.

In addition, in the device-integration method according to the embodiment of the present invention, the virtual-machine-hypervisor organizes the local-device-information and the remote-device-information in a tree-like form or a linked-list form.

In addition, the device-integration method according to the embodiment of the present invention further comprises: the virtual-machine-hypervisor periodically scans the bus configuration storage-unit, to update the local-device-information.

In addition, the device-integration method according to the embodiment of the present invention further comprises: the virtual-machine-hypervisor periodically receives updated remote-device-information from an adjacent terminal-apparatus.

In addition, in the device-integration method according to the embodiment of the present invention, the local-device-information and the remote-device-information comprise: device's manufacturer numbers, device numbers, I/O space ranges, interrupt numbers and so on.

In addition, in the device-integration method according to the embodiment of the present invention, the terminal-apparatus is a terminal-apparatus without a BIOS system.

In addition, in the device-integration method according to the embodiment of the present invention, the terminal-apparatus is an embedded terminal-apparatus, a super-computer server or a communication device, or the like.

In addition, in the device-integration method according to the embodiment of the present invention, the virtual-machine-hypervisor organizes the local devices and the remote devices on a virtual bus of the terminal-apparatus, which comprises: the virtual-machine-hypervisor, based on the local-device-information and the received remote-device-information, integrates the system resources occupied by the local devices and the system resources occupied by the remote devices.

In addition, the device-integration method according to the embodiment of the present invention further comprises: if a conflict exists between the system resources occupied by the local devices and the system resources occupied by the remote devices, then the virtual-machine-hypervisor scans the terminal-apparatus in order to re-map free system resources to the remote devices; and if there is no free system resources, then the virtual-machine-hypervisor deletes the remote devices from the virtual bus.

In addition, in the device-integration method according to the embodiment of the present invention, an operating system running on the terminal-apparatus accesses the local devices and the remote devices on the virtual bus.

In addition, in the device-integration method according to the embodiment of the present invention, the operating system accesses the remote devices on the virtual bus, which comprises: the operating system issues an I/O request for the remote devices to the virtual-machine-hypervisor, if the I/O address section to be accessed by the I/O request is in a remapped address section, then the virtual-machine-hypervisor forwards the I/O request to the remote devices; and if the I/O address section to be accessed by the I/O request is not in a remapped address section, then the virtual-machine-hypervisor forwards the I/O request to the local devices.

According to another embodiment of the present invention, there is provided a terminal-apparatus, on which there runs a virtual-machine-hypervisor, and the terminal-apparatus having a plurality of local devices, in which: the virtual-machine-hypervisor scans a bus configuration storage-unit of the terminal-apparatus, to acquire local-device-information on each of the local devices that the terminal-apparatus has; the virtual-machine-hypervisor sends the acquired local-device-information to an adjacent terminal-apparatus, and receives, from the adjacent terminal-apparatus, remote-device-information on each of the remote devices that the adjacent terminal has; the virtual-machine-hypervisor organizes the local devices and the remote devices on a virtual bus of the terminal-apparatus.

In addition, in the terminal-apparatus according to the embodiment of the present invention, the virtual-machine-hypervisor organizes the local-device-information and the remote-device-information in a tree-like form or a linked-list form.

In addition, in the terminal-apparatus according to the embodiment of the present invention, the virtual-machine-hypervisor periodically scans the bus configuration storage-unit, to update the local-device-information.

In addition, in the terminal-apparatus according to the embodiment of the present invention, the virtual-machine-hypervisor periodically receives updated remote-device-information from an adjacent terminal-apparatus.

In addition, in the terminal-apparatus according to the embodiment of the present invention, the local-device-information and the remote-device-information comprise: device's manufacturer numbers, device numbers, I/O space ranges, interrupt numbers and so on.

In addition, in the terminal-apparatus according to the embodiment of the present invention, the terminal-apparatus is a terminal-apparatus without a BIOS system.

In addition, in the terminal-apparatus according to the embodiment of the present invention, the terminal-apparatus is an embedded terminal-apparatus, a super-computer server or a communication device, or the like.

In addition, in the terminal-apparatus according to the embodiment of the present invention, the virtual-machine-hypervisor organizes the local devices and the remote devices on a virtual bus of the terminal-apparatus, which comprises: the virtual-machine-hypervisor, based on the local-device-information and the received remote-device-information, integrates the system resources occupied by the local devices and the system resources occupied by the remote devices.

In addition, in the terminal-apparatus according to the embodiment of the present invention, if a conflict exists between the system resources occupied by the local devices and the system resources occupied by the remote devices, then the virtual-machine-hypervisor scans the terminal-apparatus in order to re-map free system resources to the remote devices; and if there is no free system resources, then the virtual-machine-hypervisor deletes the remote devices from the virtual bus.

In addition, in the terminal-apparatus according to the embodiment of the present invention, an operating system running on the terminal-apparatus accesses the local devices and the remote devices on the virtual bus.

In addition, in the terminal-apparatus according to the embodiment of the present invention, the operating system accesses the remote devices on the virtual bus, which comprises: the operating system issues an I/O request for the remote devices to the virtual-machine-hypervisor, if the I/O address section to be accessed by the I/O request is in a remapped address section, then the virtual-machine-hypervisor forwards the I/O request to the remote devices; and if the I/O address section to be accessed by the I/O request is not in a remapped address section, then the virtual-machine-hypervisor forwards the I/O request to the local devices.

According to another embodiment of the present invention, there is provided a distributed multi-terminal-apparatus system, comprising a plurality of terminal-apparatuses, on each of which, a virtual-machine-hypervisor runs, and each of the terminal-apparatuses has a plurality of local devices, and the virtual-machine-hypervisor scans a bus configuration storage-unit of the terminal-apparatus, to acquire local-device-information on each of the local devices that the terminal-apparatus has; the virtual-machine-hypervisor sends the acquired local-device-information to an adjacent terminal-apparatus, and receives, from the adjacent terminal-apparatus, remote-device-information on each of the remote devices that the adjacent terminal has; the virtual-machine-hypervisor organizes the local devices and the remote devices on a virtual bus of the terminal-apparatus.

In addition, in the distributed multi-terminal-apparatus system according to the embodiment of the present invention, the virtual-machine-hypervisor organizes the local-device-information and the remote-device-information in a tree-like form or a linked-list form.

In addition, in the distributed multi-terminal-apparatus system according to the embodiment of the present invention, the virtual-machine-hypervisor periodically scans the bus configuration storage-unit, to update the local-device-information.

In addition, in the distributed multi-terminal-apparatus system according to the embodiment of the present invention, the virtual-machine-hypervisor periodically receives updated remote-device-information from an adjacent terminal-apparatus.

In addition, in the distributed multi-terminal-apparatus system according to the embodiment of the present invention, the local-device-information and the remote-device-information comprise: device's manufacturer numbers, device numbers, I/O space ranges, interrupt numbers and so on.

In addition, in the distributed multi-terminal-apparatus system according to the embodiment of the present invention, the terminal-apparatus is a terminal-apparatus without a BIOS system.

In addition, in the distributed multi-terminal-apparatus system according to the embodiment of the present invention, the terminal-apparatus is an embedded terminal-apparatus, a super-computer server or a communication device, or the like.

In addition, in the distributed multi-terminal-apparatus system according to the embodiment of the present invention, the virtual-machine-hypervisor organizes the local devices and the remote devices on a virtual bus of the terminal-apparatus, which comprises: the virtual-machine-hypervisor, based on the local-device-information and the received remote-device-information, integrates the system resources occupied by the local devices and the system resources occupied by the remote devices.

In addition, in the distributed multi-terminal-apparatus system according to the embodiment of the present invention, if a conflict exists between the system resources occupied by the local devices and the system resources occupied by the remote devices, then the virtual-machine-hypervisor scans the terminal-apparatus in order to re-map free system resources to the remote devices; and if there is no free system resources, then the virtual-machine-hypervisor deletes the remote devices from the virtual bus.

In addition, in the distributed multi-terminal-apparatus system according to the embodiment of the present invention, an operating system running on the terminal-apparatus accesses the local devices and the remote devices on the virtual bus.

In addition, in the distributed multi-terminal-apparatus system according to the embodiment of the present invention, the operating system accesses the remote devices on the virtual bus, which comprises: the operating system issues an I/O request for the remote devices to the virtual-machine-hypervisor, if the I/O address section to be accessed by the I/O request is in a remapped address section, then the virtual-machine-hypervisor forwards the I/O request to the remote devices; and if the I/O address section to be accessed by the I/O request is not in a remapped address section, then the virtual-machine-hypervisor forwards the I/O request to the local devices.

The device-integration method based on a virtualization technology, the terminal-apparatus using the device-integration method, and the distributed multi-terminal-apparatus system comprising a plurality of terminal-apparatuses, according to embodiments of the present invention, by utilizing a virtual bus, achieve an effective integration of both device-resources of local terminal-apparatuses and device-resources of remote terminal-apparatuses, as well as a real-time update of the device-information.

It should be understood that, the foregoing general description and the following detailed description are all exemplary, and are intended to provide a further explanation for the claimed techniques.

### BRIEF DESCRIPTION OF THE DRAWINGS

FIG. 1 is a schematic diagram illustrating a traditional bus structure for device-integration in the prior art;

FIG. 2 is a schematic diagram illustrating a virtual bus structure for device-integration in accordance with an embodiment of the present invention;

FIG. 3 is a schematic diagram illustrating a distributed multi-terminal-apparatus system using a virtual bus structure in accordance with an embodiment of the present invention;

FIG. 4 is a flowchart showing a device-integration method in accordance with an embodiment of the present invention; and

FIG. 5 is a functional block diagram illustrating terminal-apparatuses in a distributed multi-terminal-apparatus system in accordance with an embodiment of the present invention.

### DETAILED DESCRIPTION OF THE PREFERRED EMBODIMENTS

Hereinafter, preferred embodiments of the present invention will be described in detail with reference to the accompanying drawings.

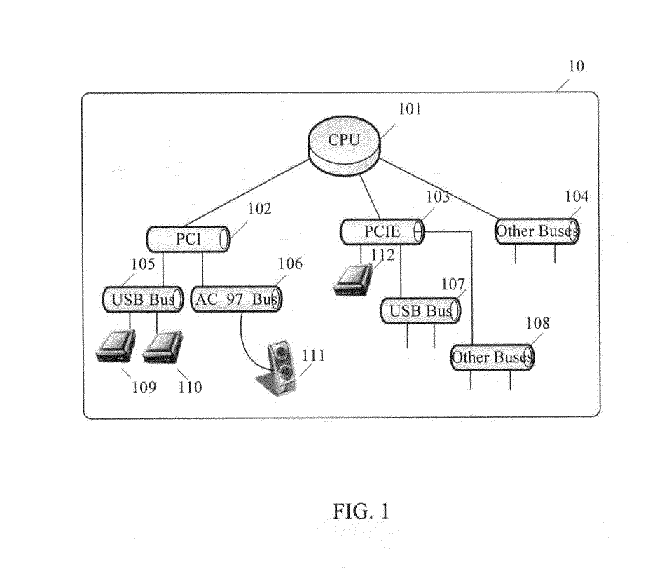

First, with reference to FIG. 1, a bus structure in the prior art will be described. The bus structure shown in FIG. 1 can be applied in a variety of terminal-apparatuses, and the terminal apparatuses are preferably apparatuses such as smart phones, personal computers, super-computer servers, or communication device, or the like. It should be noted that, as the ordinary skill in the art can easily understand, FIG. 1 is only a schematic diagram, and for the sake of brevity, only the parts which are closely related with the description of the present invention are shown, while the other parts and their descriptions are omitted.

The ordinary skill in the art can easily understand that, a bus is a set of public communication trunk-lines for transferring information among various functional components of terminal-apparatuses, and generally, it is a transmission harness composed of physical wires; in conventional computer architecture, all devices are connected through a variety of buses, especially system buses, such as ISA, AGP, PCI/PCIE etc., which are all physically existing buses. As shown in FIG. 1, a CPU 101 of a terminal-apparatus 10 has a tree-like topology connecting and controlling a PCI bus 102, a PCIE bus 103 and other buses 104, respectively. The PCI bus 102 also has a tree-like topology connecting a USB bus 105 and an AC_97 bus 106, while the PCIE bus 103 has subordinate connections with a USB bus 107 and other buses 108. In addition, as shown in FIG. 1, the USB bus 105 may have subordinate connections with a device 109 and a device 110, the AC_97 bus 106 has a subordinate connection with an audio device 111, and PCIE bus 103 has a subordinate connection with a device 112. That is, in the conventional bus structure shown in FIG. 1, all device-resources are installed on a certain bus, thus, device-resources and bus-resources are organized through a tree-like topological structure. The ordinary skill in the art can easily understand that, terminal-apparatuses may comprise other types of buses and device-resources, instead of being limited as shown in FIG. 1.

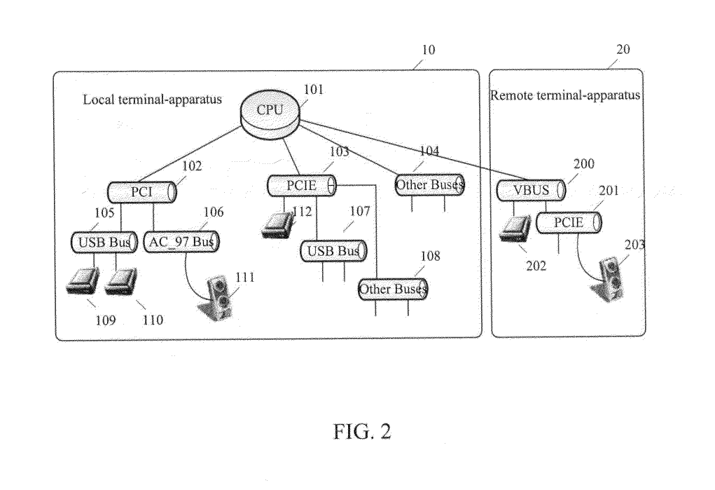

With device-resources of a terminal-apparatus being increasingly abundant, the device-resources that can be carried by a single terminal-apparatus is limited by the physical buses and the number of ports of that terminal-apparatus. Through a virtualization technology, a sharing of device-resources among different terminal-apparatuses is achieved, which will solve the above problem, and greatly improve utilization and flexibility of the resources. Below, with reference to FIG. 2, an integration of hardware-resources through a virtual bus (VBUS) based on the virtualization technology will be described.

FIG. 2 is a schematic diagram illustrating a virtual bus structure for device-integration in accordance with an embodiment of the present invention. As shown in FIG. 2, a local terminal-apparatus 10 comprises a local bus structure as shown in FIG. 1. In addition, the local terminal-apparatus 10 will share a virtual bus 200 with a remote terminal-apparatus 20. The local terminal-apparatus 10, via the virtual bus 200, can access the bus-resources and the device-resources owned by the remote terminal-apparatus 20 and connected to the virtual bus 200. Specifically, as shown in FIG. 2, the local terminal-apparatus 10, via the virtual bus 200, will access a device 202, a PCIE bus 201, as well as an audio device 203, which all belong to the remote terminal-apparatus 20. In other words, likewise, the remote terminal-apparatus 20, via the virtual bus 200, can access the PCI bus 102, the PCIE bus 103, the other buses 104, as well as the device 109, the device 110, the audio device 111, the device 112 and other devices integrated on the buses, which all belong to the remote terminal-apparatus 10.

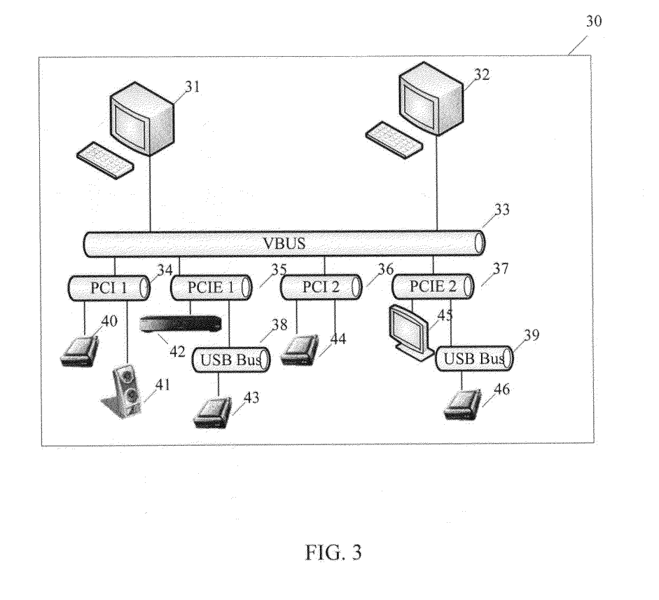

As described above according to FIG. 2, through the virtual bus 200, it achieves a sharing of the devices-resources owned by the local terminal-apparatus 10 and by the remote terminal-apparatus 20 respectively. Thus, the local terminal-apparatus 10 and the remote terminal-apparatus 20, with the use of the virtual bus 200, form a distributed multi-terminal-apparatus system. Below, with reference to FIG. 3, the distributed multi-terminal-apparatus system will be described further.

FIG. 3 shows a distributed multi-terminal-apparatus system 30 constituted by a terminal-apparatus 31 and a terminal-apparatus 32, with the use of a virtual bus 33. It should be understood that, the number of terminal-apparatuses constituting the distributed multi-terminal-apparatus system 30 is not limited to 2; instead, the system may be constituted by more terminal-apparatuses. As shown in FIG. 3, the respective physical buses of the terminal-apparatus 31 and terminal-apparatus 32, i.e., a PCI bus 34, a PCIE bus 35, a PCI bus 36, a PCIE bus 37, are arranged in a predefined topological structure and connected to the virtual bus 33. Meanwhile, the respective device-resources of the terminal-apparatus 31 and the terminal-apparatus 32, such as a device 40 to a device 46, are also arranged in a predefined topological structure and connected to the virtual bus 33 through the respective physical buses. In the distributed multi-terminal-apparatus system 30 as shown in FIG. 3, the terminal-apparatus 31 or the terminal-apparatus 32, via the virtual bus 33, can access all the device-resources owned by distributed multi-terminal-apparatus system 30. Obviously, the device-resources that the terminal-apparatus 31 or the terminal-apparatus 32 can access will not be limited to the device-resources owned by it, but including the device-resources owned by the other terminal-apparatuses in the distributed multi-terminal-apparatus system 30.

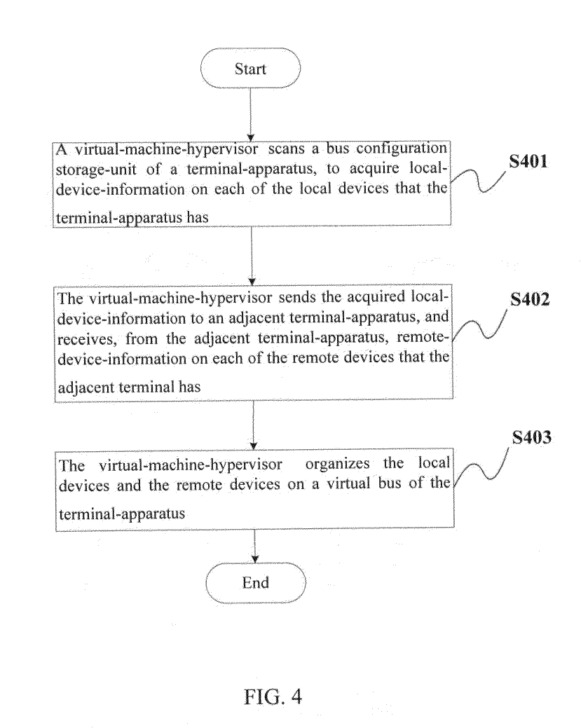

The above, with reference to FIG. 2 and FIG. 3, has described the distributed multi-terminal-apparatus system constituted by terminal-apparatuses with the use of a virtual bus structure. Below, with reference to FIG. 4, a device-integration method, executed by a terminal-apparatus on which there runs a virtual-machine-hypervisor, will be described in detail.

FIG. 4 is a flowchart showing a device-integration method in accordance with an embodiment of the present invention. The device-integration method according to the embodiment of the present invention is applied in a terminal-apparatus on which there runs a virtual-machine-hypervisor.

As shown in FIG. 4, in step S401, the virtual-machine-hypervisor scans a bus configuration storage-unit of the terminal-apparatus, to acquire local-device-information on each of the local devices that the terminal-apparatus has. In a preferred embodiment of the present invention, the terminal-apparatus is a terminal-apparatus without a BIOS system. Specifically, the terminal-apparatus is an embedded terminal-apparatus, a super-computer server or a communication device, or the like. In addition, in a preferred embodiment of the present invention, the virtual-machine-hypervisor scans a PCI/PCIE configuration space, i.e. a ROM that comes with the device itself, in order to acquire local-device-information. In another preferred embodiment of the present invention, the local-device-information and the remote-device-information comprise: device's manufacturer numbers, device numbers, I/O space ranges, interrupt numbers and so on. Then, the process proceeds to step S402.

In step S402, the virtual-machine-hypervisor sends the acquired local-device-information to an adjacent terminal-apparatus, and receives, from the adjacent terminal-apparatus, remote-device-information on each of the remote devices that the adjacent terminal has. In a preferred embodiment of the present invention, the terminal-apparatus can be connected with the adjacent terminal-apparatus through a UPnP (Universal Plug and Play), and exchange device-information. Then, the process proceeds to step S403.

In step S403, the virtual-machine-hypervisor organizes the local devices and the remote devices on a virtual bus of the terminal-apparatus. In a preferred embodiment of the present invention, the virtual-machine-hypervisor organizes the local-device-information and the remote-device-information in a tree-like form. In another preferred embodiment of the present invention, the virtual-machine-hypervisor organizes the local-device-information and the remote-device-information in a linked-list form.

Specifically, the virtual-machine-hypervisor organizes the local devices and the remote devices on a virtual bus of the terminal-apparatus, which comprises: the virtual-machine-hypervisor, based on the local-device-information and the received remote-device-information, integrates the system resources occupied by the local devices and the system resources occupied by the remote devices. That is, if a conflict exists between the system resources occupied by the local devices and the system resources occupied by the remote devices, then the virtual-machine-hypervisor scans the terminal-apparatus in order to re-map free system resources to the remote devices; and if there is no free system resources, then the virtual-machine-hypervisor deletes the remote devices from the virtual bus. Thus, the virtual-machine-hypervisor avoids resource conflicts between the local devices and the remote devices.

In addition, the device-integration method according to the embodiment of the present invention will achieve a real-time update of the device-information. Specifically, the virtual-machine-hypervisor periodically scans the bus configuration storage-unit, to update the local-device-information. Likewise, the virtual-machine-hypervisor periodically receives updated remote-device-information from an adjacent terminal-apparatus. In addition, the update to the local-device-information and the remote-device-information through the virtual-machine-hypervisor can also support hot-plug operations. That is, once a local device or a remote device is connected to the local terminal-apparatus or the remote terminal-apparatus, the virtual-machine-hypervisor will automatically update the local-device-information and the remote-device-information.

After the device-resources are integrated with the device-integration method as shown in FIG. 4, an operating system of the terminal-apparatus will be able to access the device-resources on the virtual bus. Specifically, the operating system accesses the remote devices on the virtual bus, which comprises: the operating system issues an I/O request for the remote devices to the virtual-machine-hypervisor, if the I/O address section to be accessed by the I/O request is in a remapped address section, then the virtual-machine-hypervisor forwards the I/O request to the remote devices; and if the I/O address section to be accessed by the I/O request is not in a remapped address section, then the virtual-machine-hypervisor forwards the I/O request to the local devices. In other words, for the operating system, it does not distinguish between local devices and remote devices. Only when the I/O address section to be accessed by the I/O request for a device is in a remapped address section, will the virtual-machine-hypervisor forward the I/O request to the remote devices.

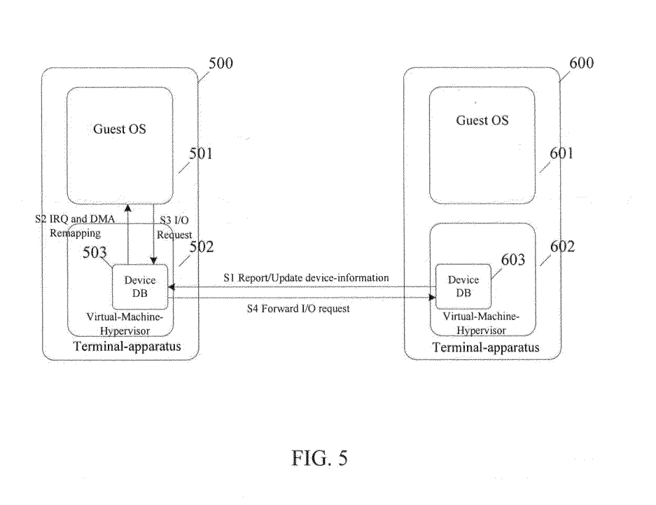

The above, with reference to FIG. 4, has described the device-integration method according to an embodiment of the present invention. Below, with reference to FIG. 5, functions of various components of a terminal-apparatus, which executes the device-integration method according to an embodiment of the present invention, will be described.

FIG. 5 is a functional block diagram illustrating terminal-apparatuses in a distributed multi-terminal-apparatus system in accordance with an embodiment of the present invention. As shown in FIG. 5, a terminal-apparatus 500 and a terminal-apparatus 600 constitute a distributed multi-terminal-apparatus system. The terminal-apparatus 500 comprises, but not limited to, a guest operating system 501 and a virtual-machine-hypervisor 502. Also, the terminal-apparatus 600 comprises, but is not limited to, a guest operating system 601 and a virtual-machine-hypervisor 602. In addition, the guest operating system 501 and the guest operating system 601 manage device-information databases 503, 603 used for storing device-information, respectively. In a preferred embodiment of the present invention, the device-information databases 503, 603 are used for storing local-device-information and remote-device-information organized on a virtual bus structure by the virtual-machine-hypervisors 502, 602.

Specifically, in step S1, the virtual-machine-hypervisor 602 of the terminal-apparatus 600 reports/updates its device-information to the virtual-machine-hypervisor 502 of the terminal-apparatus 500.

The virtual-machine-hypervisor 502 of the terminal-apparatus 500, based on the device-information received from the terminal-apparatus 600 as well as its local-device-information, updates its device-information database 503. Further, in step S2, the virtual-machine-hypervisor 502, based on the updated device-information, remaps an interrupt request (IRQ) and a direct memory access request (DMA).

When the guest operating system 501 of the terminal-apparatus 500 needs to access the hardware resources that exist in the device-information database 503, the guest operating system 501 in step S3 will send an I/O request to the virtual-machine-hypervisor 502.

After receiving the I/O request, the virtual-machine-hypervisor 502 determines whether or not the I/O address section to be accessed by the I/O request is in a remapped address section. If a positive result is obtained, then the virtual-machine-hypervisor 502 will forward the I/O request to the virtual-machine-hypervisor 602.

Through the above-described steps S1 to S4, in the distributed multi-terminal-apparatus system constituted by the terminal-apparatus 500 and the terminal-apparatus 600, it achieves a real-time update of device-resources, as well as a virtualization use of a remote device on a remote terminal-apparatus for a terminal-apparatus.

The above, with reference to FIGS. 1-5, has described the device-integration method based on a virtualization technology, the terminal-apparatus using the device-integration method, and the distributed multi-terminal-apparatus system comprising a plurality of terminal-apparatuses, according to embodiments of the present invention. According to the embodiments of the present invention, by utilizing a virtual bus, it achieves an effective integration of both device-resources of local terminal-apparatuses and device-resources of remote terminal-apparatuses, a real-time update of device-information, as well as an efficient sharing of device-resources.

It should be noted that, in this specification, the terms “comprising”, “including” or any other variant are intended to cover a non-exclusive inclusion, so that the process, method, article or device comprising a series of elements comprises not only those elements, but also comprises other elements not expressly listed, or further comprises elements inherent in this process, method, article, or device. In the case of no more restrictions, the elements defined by the statement “comprises a . . .”, do not preclude the existence of additional identical elements in the process, method, article or device comprising the elements.

Finally, it should be noted that, the above-described series of processes comprise not only the processes performed in time series in the order described herein, but also comprise the processes performed concurrently or separately, instead of in chronological order.

Through the above description of the embodiments, the skilled in the art can clearly understand that the present invention can be implemented by means of software plus a necessary hardware platform; certainly, it can also be implemented entirely by hardware. Based on such understanding, all or part of the contribution of the technical solution of the present invention to the background art, may be embodied in the form of a software product, which can be stored in a storage medium, such as a ROM/RAM, hard disk, optical disk, etc., comprising a plurality of instructions for allowing a computer device (which may be a personal computer, a server, or a network device, etc.) to perform the methods described in various embodiments or in some portion of the embodiments of the present invention.

The above has described the present invention in detail, and specific examples are used herein to explain the principles and embodiments of the invention. However, the above description of the embodiments is only used to help understanding the methods and core ideas of the present invention; meanwhile, for the ordinary skilled in the art, based on the ideas of the invention, variations can be made both in implementations and application ranges; in summary, the content of this specification should not be understood as limitative to the present invention.

1. A device-integration method, applied in a terminal-apparatus on which there runs a virtual-machine-hypervisor, the method comprising:
the virtual-machine-hypervisor scans a bus configuration storage unit of the terminal-apparatus, to acquire local-device-information on each of the local devices that the terminal-apparatus has;
the virtual-machine-hypervisor sends the acquired local-device-information to an adjacent terminal-apparatus, and receives, from the adjacent terminal-apparatus, remote-device-information on each of the remote devices that the adjacent terminal has;
the virtual-machine-hypervisor organizes the local devices and the remote devices on a virtual bus of the terminal-apparatus.

2. The device-integration method according to claim 1, wherein the virtual-machine-hypervisor organizes the local-device-information and the remote-device-information in a tree-like form or a linked-list form.

3. The device-integration method according to claim 1, further comprising:
the virtual-machine-hypervisor periodically scans the bus configuration storage unit, to update the local-device-information.

4. The device-integration method according to claim 1, further comprising:
the virtual-machine-hypervisor periodically receives updated remote-device-information from an adjacent terminal-apparatus.

5. The device-integration method according to claim 1, wherein the local-device-information and the remote-device-information comprise: device's manufacturer numbers, device numbers, I/O space ranges, interrupt numbers and so on.

6. The device-integration method according to claim 1, wherein the terminal-apparatus is a terminal-apparatus without a BIOS system.

7. The device-integration method according to claim 6, wherein the terminal-apparatus is an embedded terminal-apparatus, a super-computer server or a communication device, or the like.

8. The device-integration method according to claim 1, wherein the virtual-machine-hypervisor organizes the local devices and the remote devices on a virtual bus of the terminal-apparatus, which comprises:
the virtual-machine-hypervisor, based on the local-device-information and the received remote-device-information, integrates the system resources occupied by the local devices and the system resources occupied by the remote devices.

9. The device-integration method according to claim 8, further comprising:
if a conflict exists between the system resources occupied by the local devices and the system resources occupied by the remote devices, then the virtual-machine-hypervisor scans the terminal-apparatus in order to re-map ree system resources to the remote devices; and if there is no free system resources, then the virtual-machine-hypervisor deletes the remote devices from the virtual bus.

10. The device-integration method according to claim 9, wherein an operating system running on the terminal-apparatus accesses the local devices and the remote devices on the virtual bus.

11. The device-integration method according to claim 10, wherein the operating system accesses the remote devices on the virtual bus, which comprises: the operating system issues an I/O request for the remote devices to the virtual-machine-hypervisor, if the I/O address section accessed by the I/O request is in a remapped address section, then the virtual-machine-hypervisor forwards the I/O request to the remote devices; and if the I/O address section accessed by the I/O request is not in a remapped address section, then the virtual-machine-hypervisor forwards the I/O request to the local devices.

12. A terminal-apparatus, on which there runs a virtual-machine-hypervisor, and the terminal-apparatus having a plurality of local devices, wherein,
the virtual-machine-hypervisor scans a bus configuration storage unit of the terminal-apparatus, to acquire local-device-information on each of the local devices that the terminal-apparatus has;
the virtual-machine-hypervisor sends the acquired local-device-information to an adjacent terminal-apparatus, and receives, from the adjacent terminal-apparatus, remote-device-information on each of the remote devices that the adjacent terminal has;
the virtual-machine-hypervisor organizes the local devices and the remote devices on a virtual bus of the terminal-apparatus.

13. The terminal-apparatus according to claim 12, wherein the virtual-machine-hypervisor organizes the local-device-information and the remote-device-information in a tree-like form or a linked-list form.

14. The terminal-apparatus according to claim 12, wherein,
the virtual-machine-hypervisor periodically scans the bus configuration storage unit, to update the local-device-information.

15. The terminal-apparatus according to claim 12, wherein,
the virtual-machine-hypervisor periodically receives updated remote-device-information from an adjacent terminal-apparatus.

16. The terminal-apparatus according to claim 12, wherein the local-device-information and the remote-device-information comprise: device's manufacturer numbers, device numbers, I/O space ranges, interrupt numbers and so on.

17. The terminal-apparatus according to claim 12, wherein the terminal-apparatus is a terminal-apparatus without a BIOS system.

18. The terminal-apparatus according to claim 17, wherein the terminal-apparatus is an embedded terminal-apparatus, a super-computer server or a communication device, or the like.

19. The terminal-apparatus according to claim 12, wherein the virtual-machine-hypervisor organizes the local devices and the remote devices on a virtual bus of the terminal-apparatus, which comprises:
the virtual-machine-hypervisor, based on the local-device-information and the received remote-device-information, integrates the system resources occupied by the local devices and the system resources occupied by the remote devices.

20. The terminal-apparatus according to claim 19, wherein if a conflict exists between the system resources occupied by the local devices and the system resources occupied by the remote devices, then the virtual-machine-hypervisor scans the terminal-apparatus in order to re-map free system resources to the remote devices; and if there is no free system resources, then the virtual-machine-hypervisor deletes the remote devices from the virtual bus.

21. The terminal-apparatus according to claim 12, wherein an operating system running on the terminal-apparatus accesses the local devices and the remote devices on the virtual bus.

22. The terminal-apparatus according to claim 21, wherein the operating system accesses the remote devices on the virtual bus, which comprises: the operating system issues an I/O request for the remote devices to the virtual-machine-hypervisor, if the I/O address section accessed by the I/O request is in a remapped address section, then the virtual-machine-hypervisor forwards the I/O request to the remote devices; and if the I/O address section accessed by the I/O request is not in a remapped address section, then the virtual-machine-hypervisor forwards the I/O request to the local devices.

23. A distributed multi-terminal-apparatus system, comprising a plurality of terminal-apparatuses, wherein a virtual-machine-hypervisor runs on each of the terminal-apparatuses, and each of the terminal-apparatuses has a plurality of local devices, wherein,
the virtual-machine-hypervisor scans a bus configuration storage unit of the terminal-apparatus, to acquire local-device-information on each of the local devices that the terminal-apparatus has;
the virtual-machine-hypervisor sends the acquired local-device-information to an adjacent terminal-apparatus, and receives, from the adjacent terminal-apparatus, remote-device-information on each of the remote devices that the adjacent terminal has;
the virtual-machine-hypervisor organizes the local devices and the remote devices on a virtual bus of the terminal-apparatus.

24. The distributed multi-terminal-apparatus system according to claim 23, wherein the virtual-machine-hypervisor organizes the local-device-information and the remote-device-information in a tree-like form or a linked-list form.

25. The distributed multi-terminal-apparatus system according to claim 23, wherein,
the virtual-machine-hypervisor periodically scans the bus configuration storage unit, to update the local-device-information.

26. The distributed multi-terminal-apparatus system according to claim 23, wherein,
the virtual-machine-hypervisor periodically receives updated remote-device-information from an adjacent terminal-apparatus.

27. The distributed multi-terminal-apparatus system according to claim 23, wherein the local-device-information and the remote-device-information comprise: device's manufacturer numbers, device numbers, I/O space ranges, interrupt numbers and so on.

28. The distributed multi-terminal-apparatus system according to claim 23, wherein the terminal-apparatus is a terminal-apparatus without a BIOS system.

29. The distributed multi-terminal-apparatus system according to claim 28, wherein the terminal-apparatus is an embedded terminal-apparatus, a super-computer server or a communication device, or the like.

30. The distributed multi-terminal-apparatus system according to claim 23, wherein the virtual-machine-hypervisor organizes the local devices and the remote devices on a virtual bus of the terminal-apparatus, which comprises:
the virtual-machine-hypervisor, based on the local-device-information and the received remote-device-information, integrates the system resources occupied by the local devices and the system resources occupied by the remote devices.

31. The distributed multi-terminal-apparatus system according to claim 30, wherein if a conflict exists between the system resources occupied by the local devices and the system resources occupied by the remote devices, then the virtual-machine-hypervisor scans the terminal-apparatus in order to re-map free system resources to the remote devices; and if there is no free system resources, then the virtual-machine-hypervisor deletes the remote devices from the virtual bus.

32. The distributed multi-terminal-apparatus system according to claim 23, wherein an operating system running on the terminal-apparatus accesses the local devices and the remote devices on the virtual bus.

33. The distributed multi-terminal-apparatus system according to claim 32, wherein the operating system accesses the remote devices on the virtual bus, which comprises: the operating system issues an I/O request for the remote devices to the virtual-machine-hypervisor, if the I/O address section accessed by the I/O request is in a remapped address section, then the virtual-machine-hypervisor forwards the I/O request to the remote devices; and if the I/O address section accessed by the I/O request is not in a remapped address section, then the virtual-machine-hypervisor forwards the I/O request to the local devices.
